(19) United States
(12) Patent Application Publication
(10) Pub. No.: US 2026/0275021 A1
(43) Pub. Date: Sep. 17, 2026

(54) ETHYLENE-RICH DIENE POLYMERS HAVING A POLYVINYLPYRIDINE BLOCK, AND METHOD FOR THE SYNTHESIS THEREOF

(71) Applicant: Compagnie Generale Des Etablissements Michelin, Clermont-Ferrand (FR)

(72) Inventors: Thibaut SOUCHARD, Clermont-Ferrand (FR); Julien THUILLIEZ, Clermont-Ferrand (FR); Robert NGO, Clermont-Ferrand (FR)

(73) Assignee: Compagnie Generale Des Etablissements Michelin, Clermont-Ferrand (FR)

(21) Appl. No.: 18/877,059

(22) PCT Filed: Jun. 8, 2023
(86) PCT No.: PCT/EP2023/065365

§ 371 Date: Dec. 19, 2024

(30) Foreign Application Priority Data
Jun. 23, 2022 (FR) 2206246

(51) Int. Cl. C08F 299/02

(52) U.S. Cl. CPC C08F 299/022

(57) ABSTRACT

Block polymers containing a first statistical block comprising units of a 1,3-diene and more than 50 mol % of ethylene units, and a second polyvinylpyridine block, are provided. A process for the synthesis thereof by subsequent polymerization of the first block and the second block in the presence of a borohydrido-neodymocene complex and an organomagnesium compound is also provided.

### CROSS REFERENCE TO RELATED APPLICATIONS

This U.S. patent application is a national phase entry of PCT Patent Application No. PCT/EP2023/065365, filed Jun. 8, 2023, which claims priority to French Patent Application No. FR 2206246, filed Jun. 23, 2022, the entire contents of which are incorporated herein by reference in their entirety.

### BACKGROUND

### 1. Technical Field

The field of the invention is that of processes for synthesizing block polymers containing a statistical block of an ethylene-rich diene copolymer and a polyvinylpyridine homopolymer block.

### 2. Related Art

Copolymers based on ethylene and a 1,3-diene have beneficial properties in more than one regard. Indeed, one of the advantages lies in the use of ethylene to produce them, which is a common, commercially available monomer which can be accessed from fossil materials or biomass. The Applicant has described copolymers of ethylene and 1,3-dienes such as 1,3-butadiene, myrcene and β-farnesene which can be used in rubber compositions for tires. Reference may be made, for example, to the documents WO 2014/114607 A1, WO 2021/053051 and WO 2021/053296.

It is always of interest to develop novel processes that lead to the production of novel polymers, with the aim of continuing to propose different materials. However, block polymers resulting from the statistical polymerization of a monomer mixture comprising a 1,3-diene and ethylene and in which one of the blocks is a vinylpyridine homopolymer, are not known.

### SUMMARY

The Applicant has discovered a process which makes it possible to introduce a polyvinylpyridine block into a statistical copolymer comprising ethylene units and units of a 1,3-diene and which makes it possible to control the respective composition and length of the blocks of the block polymer. Carrying out this process makes it easy to access the synthesis of a wide variety of block polymers.

Thus, a first subject of the invention is a process for the synthesis of a block polymer comprising a first block of a statistical copolymer comprising units of a 1,3-diene and more than 50 mol % of ethylene units, and a second block of a polyvinylpyridine homopolymer, the molar percentage being expressed relative to the total number of constituent repeat units of the first block, which process comprises the copolymerization of a monomer mixture containing ethylene and a 1,3-diene in the presence of a catalytic system, followed by the homopolymerization of a vinylpyridine, the catalytic system being based on at least one metallocene of formula (I) and an organomagnesium compound

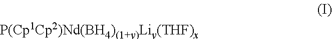

Cp¹ and Cp² being selected from the group consisting of the fluorenyl group and substituted fluorenyl groups,
P being a group bridging the two groups Cp¹ and Cp² and representing a group ZR¹R², Z representing a silicon or carbon atom, R¹ and R², which are identical or different, each representing an alkyl group comprising from 1 to 20 carbon atoms, preferably a methyl,
y is an integer equal to or greater than 0,
x is an integer or non-integer equal to or greater than 0.

A second subject of the invention is a block polymer containing a first block and a second block, the first block being a statistical copolymer comprising units of a 1,3-diene and more than 50 mol % of ethylene units, the molar percentage being expressed relative to the total number of constituent repeat units of the first block, the second block being a homopolymer of a vinylpyridine. The block polymer can be obtained by the process in accordance with the invention.

### DETAILED DESCRIPTION OF EXAMPLE EMBODIMENTS

Any interval of values denoted by the expression “between a and b” represents the range of values greater than “a” and less than “b” (that is to say limits a and b excluded), whereas any interval of values denoted by the expression “from a to b” means the range of values extending from “a” up to “b” (that is to say including the strict limits a and b).

Unless otherwise indicated, the contents of the units in the first block are expressed as a molar percentage relative to all of the constituent repeat units of the first block.

The compounds mentioned in the description may be of fossil origin or may be biobased. In the latter case, they may be partially or totally derived from biomass or obtained from renewable starting materials derived from biomass. Similarly, the compounds mentioned may also originate from the recycling of already-used materials, i.e. they may partially or totally result from a recycling process, or else be obtained from starting materials which themselves result from a recycling process.

The expression “based on” used to define the constituents of a catalytic system (or catalytic composition) is understood to mean the mixture of these constituents, or the product of the reaction of a portion or all of these constituents with one another.

The process in accordance with the invention is a process of subsequent polymerization. It comprises the statistical copolymerization of a monomer mixture containing ethylene and a 1,3-diene in the presence of a catalytic system in order to form the first block, followed by the homopolymerization of a vinylpyridine in order to form the second block. The polymerizations are carried out in the presence of a catalytic system based on at least one metallocene of formula (I) and an organomagnesium compound

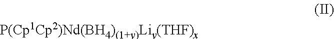

Cp¹ and Cp² being selected from the group consisting of the fluorenyl group and substituted fluorenyl groups,
P being a group bridging the two groups Cp¹ and Cp² and representing a group ZR¹R², Z representing a silicon or carbon atom, R¹ and R², which are identical or different, each representing an alkyl group comprising from 1 to 20 carbon atoms, preferably a methyl,
y is an integer equal to or greater than 0,
x is an integer or non-integer equal to or greater than 0.

In formula (I), the neodymium atom is connected to a ligand molecule consisting of the two groups Cp¹ and Cp² which are connected together by the bridge P. Preferably, the symbol P, denoted by the term bridge, corresponds to the formula ZR¹R², Z representing a silicon or carbon atom, R¹ and R², which are identical or different, representing an alkyl group comprising from 1 to 20 carbon atoms. More preferentially, the bridge P is of formula SiR¹R², R¹ and R² being identical and as defined above. More preferentially still, P corresponds to the formula SiMe₂.

As substituted fluorenyl groups, mention may be made of those substituted with alkyl groups having 1 to 6 carbon atoms or with aryl groups having 6 to 12 carbon atoms or else with trialkylsilyl groups, such as SiMe₃. When the ligands Cp¹ and Cp² are substituted, they are preferentially substituted with methyl groups, with butyl groups, notably tert-butyl groups, or with trimethylsilyl groups. These groups are preferential regardless of the embodiment of the invention. The choice of the groups is also guided by the accessibility to the corresponding molecules, which are the substituted fluorenes, because the latter are commercially available or can be easily synthesized.

As substituted fluorenyl groups, mention may particularly be made of those substituted in position 2, 7, 3 or 6, more particularly 2,7-di(tert-butyl)fluorenyl and 3,6-di(tert-butyl)fluorenyl groups. The 2, 3, 6 and 7 positions respectively denote the positions of the carbon atoms of the rings as represented in the diagram below, the 9 position corresponding to the carbon atom to which the bridge P is attached.

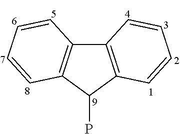

Preferably Cp¹ and CP² are identical. More preferentially, Cp¹ and Cp² each represent a fluorenyl group. The fluorenyl group is of formula C₁₃H₈. According to any one of the embodiments of the invention, the metallocene is advantageously of formula (Ia), (Ib), (Ic), (Id) or (Ie), wherein the symbol Flu represents the fluorenyl group of formula C₁₃H₈.

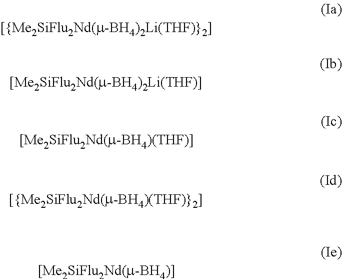

The organomagnesium compound used in the catalytic system as cocatalyst is a compound which has at least one C—Mg bond. Mention may be made, as organomagnesium compounds, of diorganomagnesium compounds, in particular dialkylmagnesium compounds, and of organomagnesium halides, in particular alkylmagnesium halides. A diorganomagnesium compound is typically of formula MgR³R⁴, wherein R³ and R⁴, which are identical or different, represent a carbon-based group. The term “carbon-based group” means a group which contains one or more carbon atoms. Preferably, R³ and R⁴ contain from 2 to 10 carbon atoms. More preferentially, R³ and R⁴ each represent an alkyl. The organomagnesium compound is preferentially a diorganomagnesium compound or an organomagnesium halide, advantageously a dialkylmagnesium compound, better still butylethylmagnesium or butyloctylmagnesium, even better still butyloctylmagnesium.

The catalytic system can be prepared conventionally by a process analogous to that described in patent application WO 2007/054224 A2 or WO 2007/054223 A2. For example, the organomagnesium compound and the metallocene are reacted in a hydrocarbon-based solvent typically at a temperature ranging from 20° C. to 80° C. for a period of between 5 and 60 minutes. The catalytic system is generally prepared in an aliphatic hydrocarbon-based solvent such as methylcyclohexane, or an aromatic hydrocarbon-based solvent such as toluene. Generally, after its synthesis, the catalytic system is used as is in the process for the synthesis of the block polymer.

Alternatively, the catalytic system can be prepared by a process analogous to that described in patent application WO 2017/093654 A1 or in patent application WO 2018/020122 A1. According to this alternative, the catalytic system further contains a preformation monomer chosen from a 1,3-diene, ethylene or a mixture of ethylene and a 1,3-diene, in which case the catalytic system is based at least on the metallocene, the organomagnesium compound and the preformation monomer. For example, the organomagnesium compound and the metallocene are reacted in a hydrocarbon-based solvent typically at a temperature of from 20° C. to 80° C. for 10 to 20 minutes, in order to obtain a first reaction product, and then the preformation monomer, chosen from a 1,3-diene, ethylene or a mixture of ethylene and a 1,3-diene, is reacted with this first reaction product at a temperature ranging from 40° C. to 90° C. for 1 h to 12 h. The preformation monomer is preferentially 1,3-butadiene or a mixture of ethylene and 1,3-butadiene. The catalytic system thus obtained can be used immediately in the process in accordance with the invention or be stored under an inert atmosphere before it is used in the polymerization process for preparing the block polymer.

The metallocene used for preparing the catalytic system can be in the form of a crystalline or non-crystalline powder, or else in the form of single crystals. The metallocene may be in monomer or dimer form, these forms depending on the method of preparation of the metallocene, as is described, for example, in patent application WO 2007/054224 A2 or WO 2007/054223 A2. The metallocene can be prepared conventionally by a process analogous to that described in patent application WO 2007/054224 A2 or WO 2007/054223 A2, in particular by reaction, under inert and anhydrous conditions, of the salt of an alkali metal of the ligand with a rare earth metal borohydride in a suitable solvent, such as an ether, for example diethyl ether or tetrahydrofuran, or any other solvent known to those skilled in the art. After reaction, the metallocene is separated from the reaction by-products by techniques known to those skilled in the art, such as filtration or precipitation from a second solvent. The metallocene is finally dried and isolated in solid form.

Like any synthesis carried out in the presence of an organometallic compound, the synthesis of the metallocene and that of the catalytic system take place under anhydrous conditions in an inert atmosphere. Typically, the reactions are performed starting with anhydrous solvents and compounds under anhydrous nitrogen or argon.

Those skilled in the art also adapt the polymerization conditions and the concentrations of each of the reagents (constituents of the catalytic system, monomers) according to the equipment (tools, reactors) used to perform the polymerization. As is known to those skilled in the art, the polymerization and the handling of the monomers, of the catalytic system and of the copolymerization solvent(s) take place under anhydrous conditions and in an inert atmosphere. The polymerization solvents are typically aliphatic or aromatic hydrocarbon-based solvents.

The polymerization is preferably performed in solution, continuously or discontinuously, in a reactor which is advantageously stirred. The polymerization solvent can be an aromatic or aliphatic hydrocarbon-based solvent. Mention may be made, as examples of polymerization solvents, of toluene and methylcyclohexane. Advantageously, the polymerization is performed in solution in a hydrocarbon-based solvent such as methylcyclohexane.

Those skilled in the art adapt the polymerization conditions, such as the polymerization temperature, the concentration of each of the reagents and the pressure in the reactor, according to the composition of the monomer mixture, the polymerization reactor and the desired microstructure and macrostructure of the copolymer chain.

The first block is synthesized by the polymerization of a monomer mixture containing ethylene and a 1,3-diene. The ethylene present in the monomer mixture containing ethylene and a 1,3-diene preferentially represents more than 50 mol % of the monomers of the monomer mixture containing ethylene and a 1,3-diene. Depending on the desired composition of the first block, those skilled in the art will adjust the molar composition of the monomer mixture containing ethylene and a 1,3-diene. In particular, they will increase the ethylene content in the monomer mixture in order to prepare a first block containing more than 50 mol % of ethylene units. According to any one of the embodiments of the invention, the monomer mixture containing ethylene and a 1,3-diene is preferentially a mixture of ethylene and a 1,3-diene. When the monomer mixture is a mixture of ethylene and a 1,3-diene, the constituent monomer units of the first block are those resulting from the copolymerization of the ethylene and the 1,3-diene.

According to the invention, the 1,3-diene of use for the requirements of the invention is just one compound, that is to say just one 1,3-diene, or is a mixture of 1,3-dienes which differ from one another by the chemical structure. For example, 1,3-dienes having 4 to 20 carbon atoms are suitable as the 1,3-diene. The 1,3-diene is preferably 1,3-butadiene, isoprene, myrcene, β-farnesene, or mixtures thereof, or a mixture of 1,3-dienes, one of which is 1,3-butadiene. The 1,3-diene is more preferentially 1,3-butadiene, a mixture of 1,3-butadiene and myrcene, or a mixture of 1,3-butadiene and S-farnesene.

The monomers of the mixture containing ethylene and a 1,3-diene can be introduced into the reactor containing the polymerization solvent and the catalytic system or, conversely, the catalytic system can be introduced into the reactor containing the polymerization solvent and the monomers.

According to any one of the embodiments of the invention, the polymerization temperature generally varies within a range of from 30° C. to 160° C., preferentially from 30° C. to 120° C. During the synthesis of the first block, the temperature of the reaction medium is advantageously kept constant during the polymerization and the total pressure in the reactor is also advantageously kept constant. Preferably, the monomer mixture containing ethylene and a 1,3-diene is polymerized at a constant ethylene pressure.

To achieve the desired macrostructure of the first block, those skilled in the art adapt the polymerization conditions, notably the molar ratio of the organomagnesium reagent to the metal Nd constituting the metallocene. The molar ratio can reach the value of 100, it being known that a molar ratio of less than 10 is more favourable for obtaining polymers of high molar masses.

During the synthesis of the first block, the constituent monomers of the monomer mixture containing ethylene and a 1,3-diene can be added continuously to the polymerization reactor, in which case the polymerization reactor is a fed reactor. This embodiment is most particularly suitable for the synthesis of a first block which is a statistical copolymer.

The synthesis of the first block is completed by cutting off the supply of monomers, in particular by a drop in the pressure of the reactor, preferably to around 3 bar. The reaction medium at the end of the synthesis of the first block is degassed, preferably by carrying out several degassings using an inert gas, for example nitrogen. The preparation of the block polymer is continued with the synthesis of the second block by subsequent homopolymerization of the vinylpyridine in the degassed reaction medium.

The vinylpyridine can be a mixture of vinylpyridines or one of the isomers of vinylpyridine, with the isomerism being determined by the substituted carbon of the aromatic ring of the pyridine. Preferably, the vinylpyridine is 4-vinylpyridine, 2-vinylpyridine or the mixture thereof. More preferentially, the vinylpyridine is 4-vinylpyridine. When the vinylpyridine is packaged in the presence of a stabilizer, as is the case for most commercial vinylpyridines, it is typically used after removal of the stabilizer, which can be carried out in a well-known manner by distillation or by contact with alumina, for example by treatment on alumina columns.

The vinylpyridine can be added to the reactor in pure form or diluted in a hydrocarbon-based solvent, preferably an aliphatic hydrocarbon-based solvent, such as methylcyclohexane. The pure or diluted vinylpyridine is introduced into the degassed reaction medium. The amount of vinylpyridine introduced into the reaction mixture, which is to be polymerized in form the second block, is adjusted by those skilled in the art according to the desired content of vinylpyridine in block form in the block polymer. It may vary within broad ranges, in particular from 0.01 to 25 g per 100 g of first block formed, more particularly from 2 g to 25 g per 100 g of block formed. The homopolymerization of the vinylpyridine is preferably carried out at a temperature identical to that of the synthesis of the first block. According to any one of the embodiments of the invention, the polymerization temperature for the synthesis of the second block generally varies within a range of from 30 to 160° C., preferentially from 30 to 120° C. The synthesis of the second block can typically be followed by chromatographic analysis in order to monitor the consumption of the vinylpyridine. The synthesis of the second block is completed when the second block reaches the desired number-average molar mass or when the conversion of the reaction for polymerizing the vinylpyridine reaches the desired conversion, for example 100%.

The synthesis of the second block can be stopped by cooling the polymerization medium or by adding an alcohol, preferentially an alcohol containing from 1 to 3 carbon atoms, for example ethanol. The block polymer can be recovered according to conventional techniques known to those skilled in the art, for instance by precipitation, by evaporation of the solvent under reduced pressure or by steam stripping.

The process in accordance with the invention enables the controlled synthesis of a block polymer in which the respective lengths and compositions of the blocks are controlled, in particular by the composition of the respective monomer feedstocks, by the molar composition of the catalytic system, and by the polymerization time.

The process according to the invention leads to the synthesis of a block polymer, which is another subject of the invention, containing two block polymers.

The essential feature of the first constituent block of the block polymer in accordance with the invention is that it is a statistical copolymer. It thus contains ethylene units and units of a 1,3-diene.

As is known, “ethylene unit” means a unit which has a —(CH₂—CH₂)— subunit. The ethylene units present in the first block represent more than 50 mol % of the constituent repeat units of the first block. The ethylene units present in the first block preferentially represent at least 65 mol % of the constituent repeat units of the first block, more preferentially at least 80 mol % of the constituent repeat units of the first block. According to any one of the embodiments of the invention, the ethylene units present in the first block preferentially represent less than 97 mol % of the total number of constituent repeat units of the first block, more preferentially less than 95 mol % of the total number of constituent repeat units of the first block.

The units of a 1,3-diene are those resulting from the polymerization of a 1,3-diene. As is known, a 1,3-diene may be inserted into a growing polymer chain by a 1,4 or 1,2 insertion, or a 3,4 insertion in the case of substituted diene such as isoprene, myrcene or 3-farnesene to give rise to the formation of the 1,3-diene unit of 1,4 configuration, the 1,3-diene unit of 1,2 configuration or of 3,4 configuration, respectively. When the first block contains units of the 1,3-diene in the 1,4 configuration, 1,4-trans units preferentially represent more than 50% of the units of 1,4 configuration, more preferentially more than 80% of the units of 1,4 configuration.

The 1,3-diene of which the monomer units constitute the first block is a 1,3-diene as defined in the described embodiments of the process in accordance with the invention.

According to a preferential embodiment of the invention, the first block contains units of the 1,3-butadiene. According to this embodiment, the 1,3-diene is preferably 1,3-butadiene or a mixture of 1,3-dienes, one of which is 1,3-butadiene. The 1,3-diene is more preferentially 1,3-butadiene.

When the 1,3-diene is 1,3-butadiene or a mixture of 1,3-dienes, one of which is 1,3-butadiene, the first block preferentially contains 1,2-cyclohexanediyl subunits, also referred to as 1,2-cyclohexanediyl units, of the following formula.

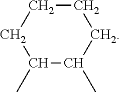

The presence of the cyclic structure in the first block results from a highly specific insertion of the ethylene and the 1,3-butadiene during their copolymerization. The mechanism for obtaining such a structure is described for example in Macromolecules 2009, 42, 3774-3779. The content of 1,2-cyclohexanediyl subunits in the first block may vary depending on the polymerization conditions for forming the first block, for example depending on the respective contents of ethylene and 1,3-butadiene in the polymerization medium, depending on the pressure in the polymerization reactor, depending on the catalytic polymerization system, as is described for example in the documents WO 2021/023924, WO 2017/103543 and WO 2018/104669. The molar content of 1,2-cyclohexanediyl subunits in the first block preferentially varies from 1% to 15% of the total number of constituent repeat units of the first block.

According to any one of the embodiments of the invention, the first block is preferentially a statistical copolymer of ethylene and the 1,3-diene, more preferentially a statistical copolymer of ethylene and the 1,3-butadiene.

The essential feature of the second constituent block of the block polymer in accordance with the invention is that it is a homopolymer of a vinylpyridine. The vinylpyridine of which the monomer units constitute the second block is a vinylpyridine as defined in the described embodiments of the process in accordance with the invention. Preferably, the vinylpyridine is 4-vinylpyridine, 2-vinylpyridine or the mixture thereof. More preferentially, the vinylpyridine is 4-vinylpyridine.

The molar content of vinylpyridine units in the block polymer can be less than 1% or much greater than 1% of the total number of constituent repeat units of the first block. It is preferentially greater than 0.1% of the total number of constituent repeat units of the first block. It is preferentially less than 50% of the total number of constituent repeat units of the first block, more preferentially less than 30% of the total number of constituent repeat units of the first block.

The block polymer according to the invention is preferentially a diblock. When the block polymer is a diblock, it is typically of formula A-B, wherein A denotes the first block and B denotes the second block.

In summary, the invention is advantageously implemented according to any one of the following Embodiments 1 to 23:
Embodiment 1: Process for the synthesis of a block polymer comprising a first block of a statistical copolymer comprising units of a 1,3-diene and more than 50 mol % of ethylene units, and a second block of a polyvinylpyridine homopolymer, the molar percentage being expressed relative to the total number of constituent repeat units of the first block, which process comprises the copolymerization of a monomer mixture containing ethylene and a 1,3-diene in the presence of a catalytic system, followed by the homopolymerization of a vinylpyridine, the catalytic system being based on at least one metallocene of formula (I) and an organomagnesium compound

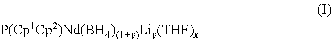

Cp¹ and Cp² being selected from the group consisting of the fluorenyl group and substituted fluorenyl groups,
P being a group bridging the two groups Cp¹ and Cp² and representing a group ZR¹R², Z representing a silicon or carbon atom, R¹ and R², which are identical or different, each representing an alkyl group comprising from 1 to 20 carbon atoms, preferably a methyl,
y is an integer equal to or greater than 0,
x is an integer or non-integer equal to or greater than 0.

Embodiment 2: Process according to embodiment 1, wherein the 1,3-diene is 1,3-butadiene, isoprene, myrcene, β-farnesene or mixtures thereof, or a mixture of 1,3-dienes, one of which is 1,3-butadiene.

Embodiment 3: Process according to embodiment 1 or 2, wherein the 1,3-diene is 1,3-butadiene, a mixture of 1,3-butadiene and myrcene, or a mixture of 1,3-butadiene and β-farnesene.

Embodiment 4: Process according to any one of embodiments 1 to 3, wherein the monomer mixture containing ethylene and a 1,3-diene is a mixture of ethylene and a 1,3-diene.

Embodiment 5: Process according to any one of embodiments 1 to 4, wherein Cp¹ and Cp² are identical and each represent a fluorenyl group.

Embodiment 6: Process according to any one of embodiments 1 to 5, wherein P corresponds to the formula SiMe₂.

Embodiment 7: Process according to any one of embodiments 1 to 6, wherein the organomagnesium compound is a diorganomagnesium compound or an organomagnesium halide.

Embodiment 8: Process according to any one of embodiments 1 to 7, wherein the organomagnesium compound is a dialkylmagnesium compound.

Embodiment 9: Process according to any one of embodiments 1 to 8, wherein the organomagnesium compound is butylethylmagnesium or butyloctylmagnesium.

Embodiment 10: Process according to any one of embodiments 1 to 9, wherein the vinylpyridine is 4-vinylpyridine, 2-vinylpyridine or the mixture thereof.

Embodiment 11: Process according to any one of embodiments 1 to 10, wherein the amount of vinylpyridine to polymerize in order to form the second block varies from 0.01 to 25 g per 100 g of first block.

Embodiment 12: Process according to any one of embodiments 1 to 11, wherein the amount of vinylpyridine to polymerize in order to form the second block varies from 2 to 25 g per 100 g of first block.

Embodiment 13: Block polymer containing a first block and a second block, the first block being a statistical copolymer comprising units of a 1,3-diene and more than 50 mol % of ethylene units, the molar percentage being expressed relative to the total number of constituent repeat units of the first block, the second block being a homopolymer of a vinylpyridine.

Embodiment 14: Block polymer according to embodiment 13, wherein the ethylene units present in the first block represent at least 65 mol % of the constituent repeat units of the first block.

Embodiment 15: Block polymer according to embodiment 13 or 14, wherein the ethylene units present in the first block represent at least 80 mol % of the constituent repeat units of the first block.

Embodiment 16: Block polymer according to any one of embodiments 13 to 15, wherein the first block is a statistical copolymer of ethylene and a 1,3-diene.

Embodiment 17: Block polymer according to any one of embodiments 13 to 16, wherein the first block is a statistical copolymer of ethylene and the 1,3-diene.

Embodiment 18: Block polymer according to any one of embodiments 13 to 17, wherein the first block contains 1,2-cyclohexanediyl subunits.

Embodiment 19: Block polymer according to embodiment 18, wherein the molar content of 1,2-cyclohexanediyl subunits in the first block varies from 1% to 15% of the total number of constituent repeat units of the first block.

Embodiment 20: Block polymer according to any one of embodiments 13 to 19, wherein the vinylpyridine is 4-vinylpyridine, 2-vinylpyridine or the mixture thereof.

Embodiment 21: Block polymer according to any one of embodiments 13 to 20, wherein the molar content of vinylpyridine units is greater than 0.1% of the total number of constituent repeat units of the first block and less than 50% of the total number of constituent repeat units of the first block.

Embodiment 22: Block polymer according to any one of embodiments 13 to 21, wherein the molar content of vinylpyridine units is greater than 0.1% of the total number of constituent repeat units of the first block and less than 30% of the total number of constituent repeat units of the first block.

Embodiment 23: Block polymer according to any one of embodiments 13 to 22, which polymer is a diblock.

### EXAMPLES

### Determination of the Microstructure of the Polymers:

For polymers having ethylene contents of less than or equal to 90 mol %: High resolution NMR spectroscopy of the polymers was carried out on a Bruker 500 Avance III HD spectrometer operating at 500 MHz equipped with a CP2 BB-1H/D Z-GRD probe for the proton. The acquisitions are made at 293 K. Deuterated chloroform (CDCl₃) is used as solvent. The samples were analysed at a concentration of approximately 1% by weight for the proton NMR (¹H NMR) analyses. The chemical shifts are determined relative to the proton signal of deuterated chloroform proton, which is fixed at 7.2 ppm. 2D analyses were performed using the following sequence: HSQC: Pulse program; hsqcedetgpsp; SW1: 165 ppm (¹³C); SW2: 12 ppm (¹H); d1: 5 s; Gradient: SMSQ10.100 and HMBC: hmbcgpndqfbaseopt; SW1: 220 ppm (¹³C); SW2: 12 ppm (¹H); d1: 5 s; Gradient: SMSQ10.100

For polymers having ethylene contents of greater than 90 mol %: High resolution NMR spectroscopy of the polymers was carried out on a Bruker 600 Avance III HD spectrometer operating at 600 MHz equipped with a CP2.1 BBO 600S3 probe for the proton. The acquisitions are made at 368 K. ortho-dichlorobenzene (o-DCB) is used as solvent. The samples were analysed at a concentration of approximately 1% by weight for the proton NMR (¹H NMR) analyses. The chemical shifts are determined relative to the proton signal of ortho-dichlorobenzene, which is fixed at 7.2 ppm. A 2D analysis was performed using the following sequence: HSQC: Pulse program; hsqcetgpsi2 “HSQC with gradients”; SW1: 180 ppm (¹³C); SW2: 12 ppm (¹H); d1: 10 s; 90° “hard” pulse ¹H P1=13 μs and 16 W and ¹³C P2=26 μs and 84 W; Gradient: SMSQ10.100.

The attribution of signals characteristic of the first block is defined in the literature, according to the paper by Llauro et al., Macromolecules, 2001, 34, 6304-6311.

The attribution of signals characteristic of the second block is defined as follows: δ¹H=8.29 ppm (═CH—N═CH—); δ¹H=6.34 ppm (═CH—C(CH₂)═CH—); δ¹³C=150 ppm (═CH—N═CH—); δ¹³C=6.34 ppm (═CH—C(CH₂)═CH—)

DOSY NMR (diffusion-ordered spectroscopy) analysis of the block polymers: The DOSY experiment, an NMR method, allows analysis of complex mixtures and detection of traces. The aim of this experiment is to show that the block polymer represents the majority of the sample and that the presence of homopolymers is very low, or absent.

The DOSY NMR analysis makes it possible to separate the species present, notably polymer matrices, by analysis of their solution diffusion coefficient. The principle of the technique is as follows:

The DOSY experiment consists in recording proton spectra while varying the force G of the gradients applied and thus the diffusion force. A linear increase in the intensity of the gradients brings about an exponential decrease in the intensity of the NMR signal. The DOSY experiment produces a two-dimensional map. The second dimension F2 of the DOSY corresponds, after Fourier transform treatment, to the 1H dimension. The first dimension F1 corresponds to the decrease of the NMR signal as a function of the applied gradient force. After treatment of the dimension F2, the diffusion coefficient is extracted using equation (1), and a DOSY map is obtained.

$$I = I 0 . exp ( - {D γ}^{2} {G}^{2} {δ}^{2} ( Δ - δ / 3 ) ) \qquad ( 1 )$$

where I is the observed intensity, 10 the reference intensity, D the diffusion coefficient, y the gyromagnetic ratio of the nucleus observed, G the force of the gradient, 6 the length of the gradient, and A the diffusion time.

If the two matrices have an identical diffusion coefficient, this means that the two matrices have the same hydrodynamic radius and are thus grafted. In contrast, if the two matrices have two different diffusion coefficients, this means that they are free with respect to each other.

The equation which describes the diffusion coefficient is as follows:

$$D = \text{?}$$

$$\text{?} \text{indicates text missing or illegible when filed}$$

wherein k_{B} is the Boltzmann constant, T the temperature, η the viscosity of the liquid in which the molecule is found, rs the hydrodynamic radius of the molecule (in this instance the matrix or the polymer).

The experiment was performed on samples of poly(butadiene-b-poly(ethylene-co-butadiene) synthesized according to the process in accordance with the invention.

The recording of two 1D ¹H NMR spectra with a diffusion filter, one with a magnetic field gradient set at 90% of the maximum power of the gradient amplifier and the other at 1% of this value, allows, by comparison with the ¹H NMR spectrum, to observe the proportion of signal loss due to the spatial diffusion of the molecules and to relaxation of the magnetization. The signal loss due to diffusion is then attributed to “small molecules” not grafted to the polymer matrix (reagents, antioxidants, solvents, etc.).

### Determination of the Macrostructure of the Polymers:

For polymers having ethylene contents of less than or equal to 90 mol %: 3D SEC method

### a) Principle of the Measurement:

Size-exclusion chromatography or SEC makes it possible to separate macromolecules in solution according to their size by passage through columns packed with a porous gel. The macromolecules are separated according to their hydrodynamic volume, the bulkiest being eluted first.

Combined with three detectors (3D), a refractometer, a viscometer and a 90° light-scattering detector, SEC makes it possible to understand the distribution of the absolute molar masses of a polymer. The various number-average (Mn) and weight-average (Mw) absolute molar masses and the dispersity (D=Mw/Mn, also denoted by PDI for polydispersity index) can also be calculated.

### b) Preparation of the Polymer:

Each sample is dissolved in tetrahydrofuran stabilized with butylhydroxytoluene (+1 vol % of diisopropylamine+1 vol % of triethylamine), at a concentration of approximately 1 g/l. The solution is then filtered through a filter with a porosity of 0.45 m before injection.

### c) 3D Sec Analysis:

To determine the number-average molar mass (Mn), and where appropriate the weight-average molar mass (Mw) and the polydispersity index (PDI) of the constituents which can be used in the compositions in accordance with the invention, the method below is used.

The number-average molar mass (Mn), the weight-average molar mass (Mw) and the polydispersity index of the constituent to be tested (hereinafter sample) are determined in an absolute manner by triple detection size exclusion chromatography (SEC). Triple detection size exclusion chromatography has the advantage of measuring average molar masses directly without calibration.

The apparatus used is a Waters Alliance chromatograph. The elution solvent is tetrahydrofuran (+1 vol % of diisopropylamine+1 vol % of triethylamine), the flow rate is 1 ml/min and the temperature of the system is 35° C. Use is made of a set of four Polymer Laboratories columns in series, having the “PL Gel Mixed B LS” trade name.

The injected volume of the solution of the polymer sample is 100 μl. The detection system used is the TDA 302 from Viscotek; this is composed of a differential refractometer, of a differential viscometer and of a 90° light scattering detector. For these 3 detectors, the wavelength is 670 nm. For the calculation of the average molar masses, the value of the increment in refractive index dn/dC of the polymer solution is integrated, which value is defined beforehand in tetrahydrofuran (+1 vol % of diisopropylamine+1 vol % of triethylamine) at 35° C. and 670 nm. The software for making use of the data is the Omnisec system from Viscotek.

For polymers having ethylene contents of greater than 90 mol %: Size exclusion chromatography is used. It will be recalled that SEC makes it possible to separate macromolecules in solution according to their size through columns packed with a porous gel. The macromolecules are separated according to their hydrodynamic volume, the bulkiest being eluted first. Without being an absolute method, SEC makes it possible to understand the distribution of the molar masses of a polymer. The various number-average molar masses (Mn) and weight-average molar masses (Mw) can be determined from commercial standards and the dispersity (D=Mw/Mn) can be calculated via a “Moore” calibration.

Preparation of the polymer: There is no particular treatment of the polymer sample before analysis. It is simply dissolved in 1,2,4-trichlorobenzene containing 300 ppm of BHT (butylated hydroxytoluene), at a concentration of approximately 1 g/l. The solution is stirred at 160° C. for 10 min before injection and the chromatographic device used is equipped with an in-line filtration system.

SEC analysis: High temperature size exclusion chromatography or HT-SEC is used. The apparatus used is a GPC-IR chromatograph equipped with an IR-6 infrared detector from Polymer Char. Detection is carried out by the IR detector on the vibration bands of the CH₂ and CH₃ groups. A set of 3 “Mixed BLS” commercial reference columns from Polymer Char is used. The elution solvent is 1,2,4-trichlorobenzene containing 300 ppm of BHT. The flow rate is 1 ml/min, the temperature of the system is 160° C. and the analysis time is 60 minutes.

The volume injected of the solution of the polymer sample is 200 μl. The software for making use of the chromatographic data is the GPC-one system from Polymer Char.

The average molar masses are determined from a calibration curve produced from PSS Ready Cal-Kit commercial polystyrene standards.

Determination of the degree of crystallinity of the polymers, their melting point and their glass transition temperature: The degree of crystallinity, the melting point and the glass transition temperature are determined by differential scanning calorimetry (DSC). The analyses are carried out on a Netzsch DSC 214 Polyma DSC device calibrated with indium. This device has a temperature range extending from −150° C. to 700° C. A computer integrated into the DSC controls the device using the Proteus software from Netzsch. The sample (approximately 10 mg) is weighed and sealed in a 40 μl aluminium crucible. The crucible is pierced with a fine needle just before the measurement. The samples are analysed under helium at 40 ml/min according to a dynamic method comprising 7 temperature steps: Step 1: cooling from 25° C. to −150° C. at 50° C./min; Step 2: isothermal at −150° C. for 5 min; Step 3: heating from −150° C. to 200° C. at 20° C./min; Step 4: isothermal at 200° C. for 5 min; Step 5: cooling from 200° C. to −150° C. at 20° C./min; Step 6: isothermal at −150° C. for 5 minutes; Step 7: heating from −150° C. to 200° C. at 20° C./min. The first four steps make it possible to erase the thermal history of the sample. The measurements of the glass transition temperature (Tg) and melting point (Tm) are carried out in the 7^{th} step. The 7^{th} step is also retained in order to obtain information on the crystallization of the sample and to determine the degree of crystallinity. The Tg and Tm values are determined by applying the data reprocessing of the Proteus software from Netzsch. The degree of crystallinity is determined by using Standard ISO 11357-3:2011 to measure the temperature and enthalpy of fusion and crystallization of the polymers used by differential scanning calorimetry (DSC). The reference enthalpy of polyethylene is 293 J/g (source: B. Wunderlich, Thermal Analysis, Academic Press, 1990, 281).

### Synthesis of the Polymers:

All the reagents are obtained commercially except for the metallocene [{Me₂SiFlu₂Nd(μ-BH₄)₂Li(THF)}], which is prepared according to the procedure described in patent application WO 2007/054224. The butyloctylmagnesium BOMAG (20% by weight in heptane, C=0.88 mol·l⁻¹) originates from Lanxess and is stored in a metal cylinder under an inert atmosphere. The ethylene, of N35 grade, originates from Air Liquide and is used without prior purification. The 1,3-butadiene is purified over alumina guard tubes. The myrcene (supplier purity: >90%) originates from DRT and is purified over alumina guard tubes. The methylcyclohexane solvent originating from BioSolve is dried and purified on an alumina column in a solvent purifier originating from mBraun and used in an inert atmosphere. All the reactions are carried out in an inert atmosphere.

### Purification of the 4-Vinylpyridine:

The purified 4-vinylpyridine is prepared according to the following procedure: 100 ml of 4-vinylpyridine (Sigma-Aldrich, 95% purity, containing 100 ppm of hydroquinone) are placed in a Steinie bottle. 30 g of alumina are introduced into the bottle. The bottle is then capped and stirred for 30 minutes at ambient temperature (23° C.) in darkness.

### Preparation of a Solution of 4-Vinylpyridine in Methylcyclohexane:

Before being used to prepare the solutions, the methycyclohexane (MCH) is purified by passing over alumina guard tubes.

A first solution of 4-vinylpyridine in MCH, solution A, is prepared by introducing 0.26 ml of purified 4-vinylpyridine into 20 ml of MCH contained in a capped 250 ml Steinie bottle under nitrogen pressure.

A second solution of 4-vinylpyridine in MCH, solution B, is prepared by introducing 0.65 ml of purified 4-vinylpyridine into 20 ml of MCH contained in a capped 250 ml Steinie bottle under nitrogen pressure.

The bottles containing solutions A and B, respectively, are pressurized at 3 bar nitrogen.

### Example 1: Preparation of a Block Polymer in Accordance with the Invention

30.4 mg (47.5 μmol) of the metallocene Me₂Si(C₁₃H₈)₂Nd(BH₄)₂Li·THF are weighed out in a 250 ml Steinie bottle in a glove box.

296 ml of MCH are introduced into a 750 ml Steinie bottle. The bottle is placed under an inert atmosphere by nitrogen bubbling for 10 minutes. 4.57 ml (499 mol, Mg/Nd=10.5) of a solution of butyloctylmagnesium at 0.11 mol/l in MCH are introduced into the 750 ml bottle containing the MCH in order to form a solution C.

A mixture of ethylene monomer and 1,3-butadiene is also prepared, containing 92 mol % ethylene and 8 mol % 1,3-butadiene, by first injecting, into a ballast, 0.48 bar of 1,3-butadiene, then 5.52 bar of ethylene in order to supplement the gaseous mixture. 6 bar absolute of a mixture containing 92 mol % ethylene and 8 mol % 1,3-butadiene is obtained (ethylene/1,3-butadiene mixture: 92/8).

The ballast is connected to a polymerization reactor.

Approximately a third of the solution C is transferred into the 250 ml bottle containing the metallocene via a cannula in order to activate the metallocene and form the catalytic system.

Half of the solution C is introduced into the stirred (at 400 rpm) reactor and brought to 77° C., with the reactor having been previously placed under an inert atmosphere. The contents of the 250 ml bottle containing the catalytic system is introduced into the reactor. The rest of the solution C is then transferred into the reactor. The reactor is degassed under vacuum until gas bubbles form and is then pressurized to 3 bar with the ethylene/1,3-butadiene mixture: 92/8.

When the pressure of the ballast registers a pressure drop corresponding to 12.7 g of monomers, the reactor is degassed using 3 venting/nitrogen cycles.

Solution A containing the 4-vinylpyridine is introduced into the reactor. Stirring is maintained for 1 hour, then the heating is switched off and the stirring stopped.

The reactor is disassembled, the polymerization medium is deactivated with 2 ml of ethanol to stop the polymerization reaction, and then is transferred into an aluminium tray and dried under vacuum at 60° C. in an oven for 24 h. The polymer recovered is white and opaque.

After 24 h, the dry polymer is recovered for the analyses. The block polymer is a diblock containing a first block of a statistical copolymer of ethylene and 1,3-butadiene and a second block of poly(4-vinylpyridine).

The first block of the block polymer contains 91 mol % of ethylene units, 6 mol % of 1,2-cyclohexanediyl units, 1 mol % of the 1,3-butadiene unit in the 1,2 configuration and 2 mol % of the 1,3-butadiene unit in the 1,4 configuration, predominantly 1,4-trans. The molar content of units of the 4-vinylpyridine is 0.5 mol % of the total number of ethylene units, of 1,2-cyclohexanediyl units, of 1,3-butadiene units in the 1,2 configuration and of 1,3-butadiene units in the 1,4-trans configuration. The block polymer, analysed by HT-SEC, has a number-average molar mass of 12 500 g/mol and a dispersity index of 1.88.

The weighed mass of block polymer makes it possible to determine the mean catalytic activity of the catalytic system, expressed in kilograms of polymer synthesized per mole of neodymium metal and per hour (kg/mol·h). The catalytic activity is 182 kg·mol/h. The Tg of the 1st block is −25° C., with crystallinity of 26%. The Tg of the polyvinylpyridine block is 160° C.

### Example 2: Preparation of a Block Polymer in Accordance with the Invention

A block polymer is prepared according to a procedure identical to that of example 1, with the sole difference being that solution A is replaced by solution B.

The first block of the block polymer contains 92 mol % of ethylene units, 5 mol % of 1,2-cyclohexanediyl units, 1 mol % of the 1,3-butadiene units in the 1,2 configuration and 2 mol % of the 1,3-butadiene units in the 1,4 configuration, predominantly 1,4-trans. The molar content of units of the 4-vinylpyridine is 1.4 mol % of the total number of ethylene units, of 1,2-cyclohexanediyl units, of 1,3-butadiene units in the 1,2 configuration and of 1,3-butadiene units in the 1,4 configuration, predominantly the 1,4-trans configuration.

The block polymer, analysed by HT-SEC, has a number-average molar mass of 12 000 g/mol and a dispersity index of 1.9.

The weighed mass of block polymer makes it possible to determine the mean catalytic activity of the catalytic system, expressed in kilograms of polymer synthesized per mole of neodymium metal and per hour (kg/mol·h). The catalytic activity is 214 kg·mol/h.

The Tg of the polyvinylpyridine block is 160° C. The crystallinity of the block polymer is 36.8%.

### Example 3: Preparation of a Block Polymer in Accordance with the Invention

100 ml of a solution of butyloctylmagnesium in MCH at 0.0009 mol/l are introduced into a 500 ml glass reactor conditioned beforehand under an inert atmosphere.

47.3 mg of metallocene [{Me₂SiFlu₂Nd(μ-BH₄)₂Li(THF)}](74 μmol) is weighed, in a glove box, into a 250 ml Steinie bottle. 100 ml of butyloctylmagnesium at 0.0009 mol/l is introduced into the Steinie bottle containing the metallocene. This solution containing the metallocene and the butyloctylmagnesium in MCH is introduced into the reactor with stirring. A further 100 ml of butyloctylmagnesium in MCH at 0.0009 mol/l are used to rinse the Steinie bottle which contained the metallocene, and are then introduced into the stirred reactor.

The reactor is subsequently conditioned under vacuum, and a gaseous mixture containing 20 mol % of 1,3-butadiene and 80 mol % of ethylene is then introduced into the reactor. The polymerization is performed at 80° C. and at an initial pressure of 4 bar absolute in the stirred reactor.

After consumption of approximately 10 g of monomers, the supply of gaseous monomers is stopped and the reaction medium is degassed by opening the reactor vents until a pressure of 1.1 bar relative is reached in the reactor. The reactor is then refilled with nitrogen up to 3 bar relative. The venting/nitrogen cycle is repeated 3 times in order to ensure the majority of the gaseous monomers are discharged.

3.2 ml of 4-vinylpyridine (29.7 mmol) in solution in 20 ml of MCH, degassed beforehand with nitrogen, is introduced into the reactor with stirring. The temperature in the reactor is maintained for 1 hour at 80° C., then the heating is switched off and the stirring stopped.

The reactor is disassembled, the polymerization medium is deactivated with 2 ml of ethanol to stop the polymerization reaction. The polymer solution is antioxidized then transferred into an aluminium tray and dried under vacuum at 60° C. with nitrogen bubbling in an oven for 24 h.

The weighed mass of block polymer makes it possible to determine the mean catalytic activity of the catalytic system, expressed in kilograms of polymer synthesized per mole of neodymium metal and per hour (kg/mol·h). The catalytic activity is 239 kg/mol·h.

The first block of the block polymer contains 90 mol % of ethylene units, 4 mol % of 1,2-cyclohexanediyl units, 2 mol % of 1,3-butadiene units in the 1,2 configuration and 4 mol % of 1,3-butadiene units in the 1,4 configuration. The molar content of units of the 4-vinylpyridine is 17.3 mol % of the total number of ethylene units, of 1,2-cyclohexanediyl units, of 1,3-butadiene units in the 1,2 configuration and of 1,3-butadiene units in the 1,4-trans configuration.

DOSY NMR analysis shows that the 1st EBR block and the second polyvinylpyridine block have the same extinction coefficient, confirming that a block polymer has been obtained. 3D SEC analysis of the polymer shows a monomodal molecular distribution and an Mn of 48 200 g/mol with a dispersity of 1.4. The DOSY NMR and 3D SEC analyses confirm that a block polymer is predominantly obtained.

The Tg of the 1st block is −36° C., with crystallinity of 1.8%. The Tg of the polyvinylpyridine block is 160° C.

### Example 4: Preparation of a Block Polymer in Accordance with the Invention

A block polymer is prepared according to a procedure identical to that of example 3, with the sole difference being that 1.3 ml of 4-vinylpyridine, instead of 3.2 ml, are introduced into the reactor.

The polymer solution is then dried in an oven under vacuum at 60° C. and under nitrogen flushing for 24 h.

The weighed mass makes it possible to determine the mean catalytic activity of the catalytic system, expressed in kilograms of polymer synthesized per mole of neodymium metal and per hour (kg/mol·h). The catalytic activity is 159 kg/mol·h.

The first block of the block polymer contains 80 mol % of ethylene units, 10 mol % of 1,2-cyclohexanediyl units, 5 mol % of 1,3-butadiene units in the 1,2 configuration and 5 mol % of 1,3-butadiene units in the 1,4 configuration. The molar content of units of the 4-vinylpyridine is 7 mol % of the total number of ethylene units, of 1,2-cyclohexanediyl units, of 1,3-butadiene units in the 1,2 configuration and of 1,3-butadiene units in the 1,4-trans configuration.

NMR analysis with application of a diffusion filter shows that the 1st EBR block and the second polyvinylpyridine block do not diffuse, and have the same extinction coefficient, confirming that a block polymer has been obtained. 3D SEC analysis of the polymer shows a monomodal molecular distribution and an Mn of 42 700 g/mol with a dispersity of 1.2. The DOSY NMR and 3D SEC analyses confirm that a block polymer is predominantly obtained. The Tg of the 1st block is −35° C., with crystallinity of 1.9%. The Tg of the polyvinylpyridine block is 160° C.

### Example 5: Preparation of a Statistical Ethylene-1,3-Butadiene Copolymer not in Accordance with the Invention

A polymer is prepared according to a procedure identical to that of example 1 except that no vinylpyridine solution is added after the copolymerization of the ethylene and the 1,3-butadiene. When the pressure of the ballast registers a pressure drop corresponding to 12.7 g of monomers, the reactor is degassed using 3 venting/nitrogen cycles and the mixture is stopped with 2 ml of ethanol.

The polymer solution is then dried in an oven under vacuum at 60° C. and under nitrogen flushing for 24 h.

The weighed mass of copolymer makes it possible to determine the mean catalytic activity of the catalytic system, expressed in kilograms of polymer synthesized per mole of neodymium metal and per hour (kg/mol·h). The catalytic activity is 191 kg/mol·h.

HT SEC analysis of the copolymer shows a monomodal molecular distribution and an Mn of 11 800 g/mol with a dispersity of 1.87.

The copolymer of ethylene and 1,3-butadiene contains 91 mol % of ethylene units, 6 mol % of 1,2-cyclohexanediyl units, 1 mol % of 1,3-butadiene units in the 1,2 configuration and 2 mol % of 1,3-butadiene units in the 1,4 configuration.

The Tg of the copolymer of ethylene and 1,3-butadiene is −21° C. The DSC thermogram shows an endothermic phenomenon when passing the transition temperature (−21° C.) identical to that of example 1.

Example 5 is a control example, because it corresponds to the synthesis of the first block of example 1.

### Example 6: Preparation of a Block Polymer in Accordance with the Invention

32 mg (50 μmol) of the metallocene Me₂Si(C₁₃H₈)₂Nd(BH₄)₂Li·THF are weighed out in a 250 ml Steinie bottle in a glove box.

298 ml of MCH are introduced into a 750 ml Steinie bottle. The bottle is placed under an inert atmosphere by nitrogen bubbling for 10 minutes. 0.51 ml (100.1 mol, Mg/Nd=2) of a solution of butyloctylmagnesium at 0.22 mol/l in MCH are introduced into the 750 ml bottle containing the MCH in order to form a solution C.

A mixture of ethylene monomer and 1,3-butadiene is also prepared, containing 80 mol % ethylene and 20 mol % 1,3-butadiene, by first injecting, into a ballast, 1.2 bar of 1,3-butadiene, then 4.8 bar of ethylene in order to supplement the gaseous mixture. 6 bar absolute of a mixture containing 80 mol % ethylene and 20 mol % 1,3-butadiene is obtained (ethylene/1,3-butadiene mixture: 80/20).

The ballast is connected to a polymerization reactor.

⅓ of the solution C is introduced into this polymerization reactor which has been degassed with nitrogen beforehand and heated to 80° C.

⅓ of the solution C is then introduced into the bottle containing the metallocene. This solution is then introduced into the polymerization reactor, followed by the final third of the solution C.

At 80° C., 10 ml (58 mmol) of myrcene is introduced into the reactor then conditioned under vacuum, then a gaseous mixture containing 20 mol % of 1,3-butadiene and 80 mol % of ethylene is introduced into the reactor. The polymerization is performed at 80° C. and at an initial pressure of 4 bar absolute in the stirred reactor.

After consumption of approximately 10 g of gaseous monomers, 7 ml (40 mmol) of myrcene are introduced into the polymerization reactor which is then conditioned under vacuum, then a gaseous mixture containing 20 mol % of 1,3-butadiene and 80 mol % of ethylene is again introduced into the reactor. The supply of gaseous monomers is stopped after consumption of 12.7 g of gaseous monomers, and the reaction medium is degassed by opening the reactor vents until a pressure of 1.1 bar relative is reached in the reactor. The reactor is then filled with nitrogen up to 3 bar relative. The venting/nitrogen cycle is repeated 3 times in order to ensure the majority of the gaseous monomers are discharged.

0.47 g of 4-vinylpyridine (4.5 mmol) in solution in 10 ml of MCH, degassed beforehand with nitrogen, is introduced into the reactor with stirring. The temperature in the reactor is maintained for 1 hour at 80° C., then the heating is switched off and the stirring stopped.

The reactor is disassembled, the polymerization medium is deactivated with 2 ml of ethanol to stop the polymerization reaction.

The polymer solution is then dried in an oven under vacuum at 60° C. and under nitrogen flushing for 24 h.

The weighed mass of block polymer makes it possible to determine the mean catalytic activity of the catalytic system, expressed in kilograms of polymer synthesized per mole of neodymium metal and per hour (kg/mol·h). The catalytic activity is 234 kg/mol·h.

3D SEC analysis of the copolymer shows Mn: 88 000 g/mol; dispersity: 1.4, representing 94% of the recovered weight of polymer.

The terpolymer of ethylene, 1,3-butadiene and myrcene contains 73 mol % of ethylene units, 4 mol % of 1,2-cyclohexanediyl units, 2 mol % of 1,3-butadiene units in the 1,2 configuration and 2 mol % of 1,3-butadiene units in the 1,4 configuration, 11 mol % of myrcene in the 3,4 configuration and 7 mol % of myrcene in the 1,4 configuration, and 0.84% of vinylpyridine.

The Tg of the terpolymer of ethylene, 1,3-butadiene and myrcene is −54° C. The terpolymer does not exhibit any crystallinity.

What is claimed is:

1. A process for the synthesis of a block polymer comprising a first block of a statistical copolymer comprising units of a 1,3-diene and more than 50 mol % of ethylene units, and a second block of a polyvinylpyridine homopolymer, the molar percentage being expressed relative to the total number of constituent repeat units of the first block, which process comprises the copolymerization of a monomer mixture containing ethylene and a 1,3-diene in the presence of a catalytic system, followed by the homopolymerization of a vinylpyridine,
the catalytic system being based on at least one metallocene of formula (I) and an organomagnesium compound 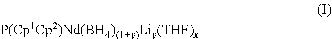
Cp¹ and Cp² being selected from the group consisting of the fluorenyl group and substituted fluorenyl groups,
P being a group bridging the two groups Cp¹ and Cp² and representing a group ZR¹R², Z representing a silicon or carbon atom, R¹ and R², which are identical or different, each representing an alkyl group comprising from 1 to 20 carbon atoms,
y is an integer equal to or greater than 0,
x is an integer or non-integer equal to or greater than 0.

2. The process according to claim 1, wherein the 1,3-diene is 1,3-butadiene, isoprene, myrcene, β-farnesene or mixtures thereof, or a mixture of 1,3-dienes, one of which is 1,3-butadiene.

3. The process according to claim 1, wherein the 1,3-diene is 1,3-butadiene, a mixture of 1,3-butadiene and myrcene, or a mixture of 1,3-butadiene and β-farnesene.

4. The process according to claim 1, wherein the monomer mixture containing ethylene and a 1,3-diene is a mixture of ethylene and a 1,3-diene.

5. The process according to claim 1, wherein Cp¹ and Cp² are identical and each represent a fluorenyl group.

6. The process according to claim 1, wherein P corresponds to the formula SiMe₂.

7. The process according to claim 1, wherein the organomagnesium compound is a diorganomagnesium compound or an organomagnesium halide.

8. The process according to claim 1, wherein the organomagnesium compound is a dialkylmagnesium compound.

9. The process according to claim 1, wherein the vinylpyridine is 4-vinylpyridine, 2-vinylpyridine or the mixture thereof.

10. A block polymer containing a first block and a second block, the first block being a statistical copolymer comprising units of a 1,3-diene and more than 50 mol % of ethylene units, the molar percentage being expressed relative to the total number of constituent repeat units of the first block, the second block being a homopolymer of a vinylpyridine.

11. The block polymer according to claim 10, wherein the ethylene units present in the first block represent at least 65 mol % of the constituent repeat units of the first block.

12. The block polymer according to claim 10, wherein the first block is a statistical copolymer of ethylene and a 1,3-diene.

13. The block polymer according to a claim 10, wherein the first block contains 1,2-cyclohexanediyl subunits.

14. The block polymer according to claim 10, wherein the vinylpyridine is 4-vinylpyridine, 2-vinylpyridine or the mixture thereof.

15. The block polymer according to claim 10, which polymer is a diblock.

16. The process according to claim 1, wherein R¹ and R² each represent a methyl.

17. The process according to claim 8, wherein the dialkylmagnesium compound is butylethylmagnesium or butyloctylmagnesium.

18. The block polymer according to claim 11, wherein the ethylene units present in the first block represent at least 80 mol % of the constituent repeat units of the first block.

19. The block polymer according to claim 12, wherein the statistical copolymer is a statistical copolymer of ethylene and 1,3-butadiene.

20. The block polymer according to claim 13, wherein the molar content of 1,2-cyclohexanediyl subunits in the first block range from 1 to 15% of the total number of constituent repeat units of the first block.
